(19) United States
(12) Patent Application Publication
(10) Pub. No.: US 2006/0127658 A1
(43) Pub. Date: Jun. 15, 2006

(54) Multilayered laminate for tubes and other similar film-type packagings with an embedded barrier layer

(76) Inventors: Detlev Schulz, Dietmannsried (DE); Arno Holzmuller, Kempten (DE)

Correspondence Address: KNOBBE MARTENS OLSON & BEAR LLP, 2040 MAIN STREET, FOURTEENTH FLOOR, IRVINE, CA, 92614, US

(21) Appl. No.: 10/534,680

(22) PCT Filed: Sep. 11, 2003
(86) PCT No.: PCT/EP03/10125

§ 371 Date: Dec. 27, 2005

(30) Foreign Application Priority Data
Nov. 15, 2002 (DE) 10253395.4
Dec. 23, 2002 (DE) 10260695.1

(51) Int. Cl. B32B 15/08

(52) U.S. Cl. 428/215; 428/458; 428/461; 428/463; 156/244.13

(57) ABSTRACT

The invention relates to a multi-layer laminate for tubes and similar foil-type packaging having an embedded barrier layer, a metal—especially aluminium—foil and optionally an outer structure, especially an outer and/or sealing film, wherein the barrier layer consists of polyamide (PA), especially aromatic and/or partly aromatic polyamide or mixtures thereof, of mixtures of PA with polyacrylonitrile (PAN) and/or ethylene vinyl alcohol copolymer (EVOH), or of polyethylene terephthalate (PET). The invention further relates to a method of producing said laminate.

The invention relates to a multi-layer laminate for tubes and similar foil-type packaging having an embedded barrier layer and to a method for the production thereof, in accordance with the preambles of patent claim 1 and of patent claim 8, respectively.

Multi-layer laminates are required in the packaging industry sector. They have flexible to relatively dimensionally stable properties, depending on the thickness of the laminate, and are used in the manufacture of tubes, bags and stand-up packaging. In particular, the multi-layer laminates having an embedded barrier layer are suitable for the packaging of aggressive substances and of aromatic substances. This is based on the fact that a blocking layer is provided in the multi-layer laminate, which blocking layer prevents the escape of aggressive substances, for example peroxides, and also acidic, basic and—in particular, volatile—solvent-containing substances. The escape of volatile flavouring substances and aromatic substances is also prevented by means of the blocking layer.

Hitherto, a blocking layer of such a kind consisted usually of a metal foil arranged within the laminate. It has been found, however, that such a foil has shortcomings, especially in relation to highly corrosive or readily diffusing materials, in the worst case even giving rise, depending on the packaged material, to denaturation of the metal layer (usually an aluminium foil), for example as a result of oxidation.

An improvement in that regard was provided by the U.S. Pat. No. 5,098,794, which proposes an additional barrier layer of an ethylene vinyl alcohol copolymer for protection of the metallic blocking layer. However, the laminate in that case is suitable only for packaged materials that behave inertly with respect to the ethylene vinyl alcohol copolymer.

The problem of the invention is to make available a multi-layer laminate—and a method for the production thereof—which avoids the above-mentioned disadvantages, which can be used universally and which has an improved retaining capability with respect to aggressive, volatile and readily diffusing substances.

The problem is solved by a multi-layer laminate in accordance with patent claim 1 and by a method of producing such a laminate in accordance with patent claim 8.

In particular, the problem is solved by a multi-layer laminate for tubes and similar foil-type packaging having an embedded barrier layer, a metal—especially aluminium—foil, and, optionally, an outer structure, especially an outer and/or sealing film, the barrier layer consisting of one or more, especially mixtures, of the following materials:
polyamide (PA), especially aromatic and/or partly aromatic polyamide or mixtures thereof,
mixtures of polyamide (PA), especially aromatic and/or partly aromatic polyamide or mixtures thereof, with ethylene vinyl alcohol copolymer (EVOH) and/or polyacrylonitrile (PAN),
polyethylene terephthalate (PET),
polyacrylonitrile (PAN).

The major advantage in using polyamide, especially in aromatic and/or partly aromatic form and mixtures thereof, and also polyethylene terephthalate, mixtures of polyamide with ethylene vinyl alcohol copolymer and/or polyacrylonitrile, or polyacrylonitrile lies in a very wide application spectrum. Accordingly, by selection of its basic and/or mixing constituents, the polyamide can be so produced that it behaves inertly or at least substantially inertly with respect to the aggressive or volatile substances present in the packaged material.

As an alternative to using polyamide as the barrier layer material, polyethylene terephthalate can be used. The latter has excellent resistance to chemicals. In addition, it can be highly compressed so that the barrier properties, especially in respect of diffusion, are further improved.

As another barrier layer material there is used polyacrylonitrile, especially in admixture with polyamide and/or ethylene vinyl alcohol copolymer. The use of this barrier layer material has been found to be especially advantageous, especially because polyacrylonitrile can simultaneously serve as sealing layer material. Accordingly, the application of an inner sealing layer may, where appropriate, be omitted.

In accordance with the invention, a barrier layer consists solely of one of the mentioned barrier layer materials, that is to say either of polyamide, polyacrylonitrile, optionally in admixture with ethylene vinyl alcohol copolymer, or of polyethylene terephthalate; it is, however, possible to provide a barrier layer of two or more layers. By that means it is possible, for example, to provide long-term receptacles for extremely corrosive or highly volatile packaged materials. The nature of the combination and mixture of the particular polyamide, polyacrylonitrile and polyethylene terephthalate layers will be based on the particular requirements.

Polyamide (PA) can be used both in oriented form and in amorphous form.

However, it is to be emphasised that, most generally, a single mono-layered barrier layer of polyamide, mixtures thereof with polyacrylonitrile and/or ethylene vinyl alcohol copolymer, or polyethylene terephthalate is sufficient to shield the blocking layer of metal foil from the packaged materials.

In accordance with an embodiment, the barrier layer is arranged on the inside of the packaging, between an inner sealing or contact layer and the metal foil or layer, especially as part of an inner film.

This arrangement ensures that aggressive or volatile packaged materials come into contact with the barrier layer first, and the metal foil, which is preferably made of aluminium, is not exposed to the influence of the packaged materials.

Depending on the particular requirements and layer thicknesses, the barrier layer is then provided as part of an inner film, in which case it is possible for the inner film to be handled separately—especially in the case of large layer thicknesses—and, for example, applied as a protective layer to aluminium surfaces, for example of containers.

In accordance with the invention, there is provided, between the barrier layer and the metal foil, a central sealing layer and/or an especially extruded connecting layer. The central sealing layer, which can be in the form of an olefinic layer and which substantially corresponds to the inner sealing or contact layer, serves, on the one hand, to stabilise the layer structure and also to allow an optimised connection to the preferably extruded connecting layer. The connecting layer is so formed that it in turn adheres to the aluminium foil.

In accordance with the invention, an adhesion promoter is provided between the layers surrounding the barrier layer, especially between the inner sealing layer and the barrier layer and between an outer layer and the barrier layer. The adhesion promoter serves to improve adhesion between the inner sealing or contact layer and the barrier layer and to improve adhesion between the barrier layer and the central sealing layer. These layers form the afore-mentioned inner film. Following on, adjacent thereto, is the preferably extruded connecting layer, which is followed by the aluminium foil. The aluminium foil is in turn, on the outside, provided with an outer structure, for example an extruded film, for example in the form of an outer or sealing film, which comprises olefins.

In accordance with a further embodiment of the invention, the metal—especially aluminium—foil is coated with a chromium-complex-comprising, especially lacquer-like, material. This chromium complex coating is ideally lacquered onto the aluminium foil and additionally protects the latter from strong oxidising products such as, for example, peroxides.

The layer thicknesses possible in accordance with the invention and the materials preferred for the individual layers can be found in Tables 1 and 2, which follow:

TABLE 1

| | | | Especially |
|---|---|---|---|
| | | Preferred layer | preferred layer |
| Layer | Layer thickness | thickness | thickness |
| Inner sealing or | 1 μm-250 μm | 3 μm-150 μm | 5 μm-100 μm |
| contact layer | | | |
| Adhesion romoter | 1 μm-140 μm | 3 μm-40 μm | 5 μm-25 μm |
| Barrier layer | 1 μm-180 μm | 2 μm-80 μm | 3 μm-50 μm |
| Central sealing layer | 1 μm-250 μm | 3 μm-150 μm | 5 μm-100 μm |
| Connecting layer | 1 μm-180 μm | 3 μm-80 μm | 5 μm-50 μm |
| Metal foil | 1 μm-150 μm | 3 μm-65 μm | 5 μm-40 μm |
| Outer structure | 1 μm-300 μm | 0 μm-190 μm | 0 μm-110 μm |

TABLE 2

| Layer | Material(s) |
|---|---|
| Inner sealing or contact layer | Polyethylene (PE), polypropylene (PP), modified |
| | olefins, especially ionomers, ethylene acrylic acid |
| | (EAA), polyacrylonitrile (PAN), ethylene methacrylate |
| | (EMA), mixtures of afore-mentioned materials |
| Adhesion promoter | Maleic anhydride (MA), modified olefins, especially |
| | ionomers, mixtures of afore-mentioned materials |
| Central sealing layer | Polyethylene (PE), polypropylene (PP), modified |
| | olefins, especially ionomers, ethylene acrylic acid |
| | (EAA), polyacrylonitrile (PAN), ethylene methacrylate |
| | (EMA), mixtures of afore-mentioned materials |
| Connecting layer | Ethylene acrylic acid (EAA), ethylene methacrylate |
| | (EMA), maleic anhydride (MA), modified olefins, |
| | especially ionomers, polyethylene (PE), mixtures of |
| | afore-mentioned materials |
| Outer structure | Polyethylene (PE), polypropylene (PP), modified |
| | olefins, especially ionomers, ethylene acrylic acid |
| | (EAA), polyacrylonitrile (PAN), ethylene methacrylate |
| | (EMA), colorants, mixtures of afore-mentioned |
| | materials |

Accordingly, the basic structure of the multi-layer laminate according to the invention is as follows:
inner film, consisting of:
   inner sealing/contact layer of PE, PP, PAN or modified olefins such as ionomers, EAA, and mixtures thereof;
   adhesion promoter of MA, modified olefins, and mixtures thereof;
   barrier layer consisting of PA, partly aromatic PA, aromatic PA, mixtures of PA with PAN and/or EVOH, PAN, PET and mixtures thereof;
   adhesion promoter of MA, modified olefins, and mixtures thereof;
   central sealing/contact layer, basic structure as the sealing layer (but need not necessarily be the same as the sealing layer);
extruded connecting layer of EAA, EMA, MA, ionomer or other modified olefins, can also be a co-extrudate with PE or two of the mentioned materials;
aluminium foil;
outer structure comprising extruded layer in the form of an outer/sealing layer of olefinic composition.

The problem according to the invention is further solved by a method of producing a multi-layer laminate for tubes and similar foil-type packaging having an embedded barrier layer, a metal—especially aluminium—foil and, optionally, an outer structure, especially an outer and/or sealing film, wherein there is used, as the barrier layer, one or more of the following materials, especially mixtures thereof:
polyamide (PA), especially aromatic and/or partly aromatic polyamide or mixtures thereof,
mixtures of polyamide (PA), especially aromatic and/or partly aromatic polyamide or mixtures thereof, with ethylene vinyl alcohol copolymer (EVOH) and/or polyacrylonitrile (PAN),
polyethylene terephthalate (PET),
polyacrylonitrile (PAN).

In accordance with an embodiment of the invention, an inner film consisting of at least a sealing or contact layer and the barrier layer and at least one adhesion promoter arranged between the barrier layer and the sealing or contact layer is co-extruded.

In accordance with a further embodiment, the barrier layer is produced in the form of a film and is applied to the inner sealing or contact layer by means of extrusion lamination or adhesive lamination.

At this point it should be mentioned that the central sealing layer, which is located in the interior of the laminate and is in the form of an olefin layer, is optional and can be omitted where that is desirable, whereas the inner sealing layer is necessary in accordance with the invention.

Accordingly, in accordance with a further embodiment of the invention, the inner sealing or contact layer, the barrier layer and, optionally, a central sealing or contact layer are applied directly onto the metal layer, where appropriate using an adhesion promoter, especially a primer, preferably a methacrylate. By that means, a polyethylene/poly-amide/(polyethylene) structure is applied to the aluminium by means of co-extrusion coating, where appropriate with the aid of a suitable primer, so that the inner olefin layer or, when that is omitted as indicated by the brackets, the polyamide layer is directly adjacent to the aluminium foil.

It should be mentioned that the alternative materials mentioned in the Table for the individual layers can of course be used.

In accordance with the invention it is furthermore possible to coat the metal—especially aluminium—foil with a chromium-complex-comprising, especially lacquer-like, material. By that means, the resistance of the aluminium foil with respect to strong oxidising substances can be substantially improved.

In the course of the method, the layer thicknesses mentioned in Tables 1 and 2 are produced and the materials for producing the particular layers are used.

It should be mentioned at this point that the outer structure can comprise colorants. In accordance with the invention, the latter also include labels and other means suitable for forming a design or product identifier. These may be applied to the aluminium foil in the form of a layer or foil or as an integral constituent of the outer structure. Moreover, printing may be applied directly to the aluminium foil.

Further embodiments of the invention are to be found in the subordinate claims.

The invention is described hereinbelow with reference to an exemplifying embodiment, which will be explained in greater detail with reference to the drawing, in which:

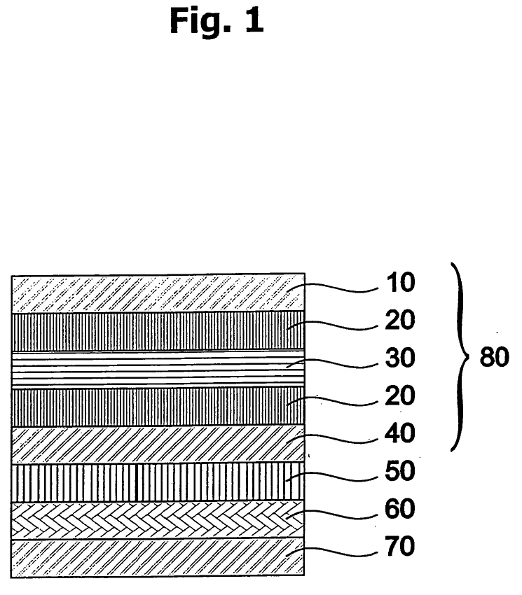

FIG. 1 is a diagrammatic representation of the layer structure of a laminate according to the invention.

In the description that follows, the same reference numerals are used for parts that are the same and that act in the same manner.

Following on adjacent to an innermost sealing or contact layer 10, which faces the packaged materials and is of polyethylene (PE), polypropylene (PP), modified olefins, for example ionomers, or ethylene acrylic acid (EAA) or like acrylic compounds, including mixtures of the afore-mentioned materials, is a layer of an adhesion promoter 20 of maleic anhydride (MA), modified olefins, especially ionomers, or mixtures thereof. The sealing or contact layer 10 has a layer thickness of 5 μm, whilst the adhesion promoter layer 20 has a thickness of from 5 μm to 25 μm. Following on adjacent to the adhesion promoter layer 20 is the barrier layer 30 consisting of polyamide, partly aromatic polyamide, aromatic polyamide or mixtures thereof and having a layer thickness of from 3 μm to 50 μm. An alternative material to polyamide is polyethylene terephthalate. Following on, adjacent thereto, are three layers, which can optionally be omitted individually or jointly: the innermost of those optional layers consists of an adhesion promoter 20 of the above-mentioned kind and is followed by an olefinic layer 40, which represents the central sealing layer 40 and the structure of which corresponds to, without necessarily having to correspond to, the inner sealing layer 10. In respect of layer thickness, the adhesion promoter layer 20 and the central sealing layer 40 correspond to the thicknesses of the afore-mentioned corresponding layers 20, 10 located further inwards. The hitherto mentioned layers can be in the form of an inner film 80, which has a layer thickness in the range from 25 μm to 300 μm. The inner film 80 is preferably co-extruded.

In the direction towards the outside, following on adjacent to the central sealing layer 40 is a preferably extruded connecting layer 50 of ethylene acrylic acid (EAA), polyacrylo-nitrile (PAN), ethylene methacrylate (EMA), maleic anhydride (MA), or of modified olefins, especially ionomers. The extruded connecting layer 50 can also be a co-extrudate of polyethylene (PE) with one or two of the afore-mentioned materials. The thickness of the extruded connecting layer 50 is in the range from 5 μm to 50 μm.

Following on adjacent to the extruded connecting layer 50 in the direction towards the outside is the aluminium foil 60, having a thickness of from 5 μm to 40 μm.

As the outermost layer, there follows an outer structure 70 of an extruded layer and an outer or sealing film, which has a substantially olefinic composition.

The overall thickness of a multi-layer laminate according to the invention is in the range from 150 μm to 500 μm.

At this point it should be stated that all above-described parts, considered on their own and in any combination, especially the details shown in the drawing, are claimed as being important for the invention. The skilled person will be familiar with modifications thereof.

### List of Reference Numerals

10 inner sealing or contact layer
20 adhesion promoter
30 barrier layer
40 central sealing or contact layer
50 connecting layer
60 metal foil
70 outer structure
80 inner film

1. A multi-layer laminate for tubes and similar foil-type packaging comprising an embedded barrier layer, and a metal foil wherein the barrier layer consists of one or more, of the following materials:
polyamide (PA),
mixtures of polyamide (PA) with ethylene vinyl alcohol copolymer (EVOH) and/or polyacrylonitrile (PAN),
polyethylene terephthalate (PET),
polyacrylonitrile (PAN).

2. The laminate according to claim 1, wherein the barrier layer is arranged on the inside of the packaging, between an inner sealing or contact layer and the metal foil or layer.

3. The laminate according to one of claim 1, further comprising between the barrier layer and the metal foil, a central sealing layer and/or a connecting layer.

4. The laminate according to claim 1, wherein an adhesion promoter is provided between the barrier layer and layers surrounding the barrier layer.

5. The laminate according to claim 1, wherein the metal is coated with a chromium-complex-comprising material.

6. The laminate according to claim 1, wherein layers present and their thicknesses are in accordance with the following table:

| Layer | Layer thickness |
|---|---|
| Inner sealing or contact | 1 μm-250 μm |
| layer | |
| Adhesion promoter | 1 μm-140 μm |
| Barrier layer | 1 μm-180 μm |
| Central sealing layer | 1 μm-250 μm |
| Connecting layer | 1 μm-180 μm |
| Metal foil | 1 μm-150 μm |
| Outer structure | 1 μm-300 μm |

7. The laminate according to claim 1, wherein layers comprise materials in accordance with the following table, in each case singly or in combination:

| Layer | Material(s) |
|---|---|
| Inner sealing or | Polyethylene (PB), polypropylene (PP), modified olefins, |
| contact layer | ethylene acrylic acid (EAA), polyacrylonitrile (PAN), |
| | ethylene methacrylate (EMA), mixtures of afore-mentioned materials |
| Adhesion | Maleic anhydride (MA), modified olefins, |
| promoter | mixtures of afore-mentioned materials |
| Central sealing | Polyethylene (PB), polypropylene (PP), modified olefins, |
| layer | ethylene acrylic acid (EAA), polyacrylonitrile (PAN), |
| | ethylene methacrylate (EMA), mixtures of afore-mentioned materials |
| Connecting layer | Ethylene acrylic acid (EAA), ethylene methacrylate (EMA), maleic |
| | anhydride (MA), modified olefins, polyethylene |
| | (PE), mixtures of afore-mentioned materials |
| Outer structure | Polyethylene (PB), polypropylene (PP), modified olefins, |
| | ethylene acrylic acid (EAA), polyacrylonitrile (PAN), |
| | ethylene methacrylate (BMA), colorants, mixtures of afore-mentioned |
| | materials |

8. A method of producing a multi-layer laminate for tubes and similar foil-type packaging said laminate comprising an embedded barrier layer, a metal, wherein as the barrier layer there is used
polyamide (PA),
mixtures of polyamide (PA), with ethylene vinyl alcohol copolymer (EVOH) and/or polyacrylonitrile (PAN),
polyethylene terephthalate (PET),
polyacrylonitrile (PAN).

9. The method according to claim 8, wherein an inner film consisting of at least a sealing or contact layer and the barrier layer and at least one adhesion promoter arranged between the barrier layer and the sealing or contact layer is co-extruded.

10. The method according to claim 8, wherein the barrier layer is produced in the form of a film and applied to an inner sealing or contact layer by means of extrusion lamination or adhesive lamination.

11. The method according to claim 8, wherein an inner sealing or contact layer, and the barrier layer are applied directly onto the metal layer, where appropriate using an adhesion promoter.

12. The method according to claim 8, wherein the metal foil is coated with a chromium-complex-comprising material.

13. The method according to claim 8, wherein particular layers produced and thicknesses thereof are in accordance with the following table:

| Layer | Layer thickness |
|---|---|
| Inner sealing or contact | 1 μm-250 μm |
| layer | |
| Adhesion promoter | 1 μm-140 μm |
| Barrier layer | 1 μm-180 μm |
| Central sealing layer | 1 μm-250 μm |
| Connecting layer | 1 μm-180 μm |
| Metal foil | 1 μm-150 μm |
| Outer structure | 1 μm-300 μm |

14. The method according to claim 8, wherein particular layers are produced with materials in accordance with the following table:

| Layer | Material(s) |
|---|---|
| Inner sealing or | Polyethylene (PB), polypropylene (PP), modified olefins, |
| contact layer | ethylene acrylic acid (EAA), polyacrylonitrile (PAN), |
| | ethylene methacrylate (EMA), mixtures of afore-mentioned materials |
| Adhesion | Maleic anhydride (MA), modified olefins, |
| promoter | mixtures of afore-mentioned materials |
| Central sealing | Polyethylene (PB), polypropylene (PP), modified olefins, |
| layer | ethylene acrylic acid (EAA), polyacrylonitrile (PAN), |
| | ethylene methacrylate (EMA), mixtures of afore-mentioned materials |
| Connecting layer | Ethylene acrylic acid (EAA), ethylene methacrylate (EMA), maleic |
| | anhydride (MA), modified olefins, polyethylene |
| | (PE), mixtures of afore-mentioned materials |
| Outer structure | Polyethylene (PB), polypropylene (PP), modified olefins, |
| | ethylene acrylic acid (EAA), polyacrylonitrile (PAN), |
| | ethylene methacrylate (EMA), colorants, mixtures of afore-mentioned |
| | materials |

15. The laminate of claim 1, wherein the metal foil is an aluminium foil.

16. The laminate of claim 1, further comprising an outer structure comprising an outer and/or sealing film.

17. The laminate of claim 1, wherein the barrier layer comprises polyamide, said polyamide being aromatic and/or partly aromatic polyamide or a mixture thereof.

18. The laminate of claim 1, wherein the barrier layer consists of a mixture of one or more of said materials.

19. The laminate of claim 1, wherein layer thicknesses are in accordance with the following table:

| Layer | Layer thickness |
|---|---|
| Inner sealing or contact layer | 3 μm-150 μm |
| Adhesion promoter | 3 μm-40 μm |
| Barrier layer | 2 μm-80 μm |
| Central sealing layer | 3 μm-150 μm |
| Connecting layer | 3 μm-80 μm |
| Metal foil | 3 μm-65 μm |
| Outer structure | 0 μm-190 μm |

20. The laminate of claim 1, wherein layer thicknesses are in accordance with the following table:

| Layer | Layer thickness |
|---|---|
| Inner sealing or contact layer | 5 μm-100 μm |
| Adhesion promoter | 5 μm-25 μm |
| Barrier layer | 5 μm-50 μm |
| Central sealing layer | 5 μm-100 μm |
| Connecting layer | 5 μm-50 μm |
| Metal foil | 5 μm-40 μm |
| Outer structure | 0 μm-110 μm |

21. The laminate of claim 2, wherein the barrier layer is part of an inner film.

22. The laminate of claim 3, wherein the connecting layer, where present, is an extruded layer.

23. The laminate of claim 4, further comprising an adhesion promoter between the barrier layer and the inner sealing layer and an outer layer.

24. The laminate of claim 5, wherein said chromium-complex-comprising material is laquer-like.

25. The laminate of claim 7, wherein said modified olefins are ionomers.

26. The method of claim 8, wherein the metal foil is an aluminium foil.

27. The method of claim 8, wherein said multi-layer laminate further comprises an outer structure comprising an outer and/or sealing film.

28. The method of claim 8, wherein the barrier layer comprises polyamide, said polyamide being aromatic and/pr partly aromatic polyamide or a mixture thereof.

29. The method of claim 8, wherein the adhesion promoter is a primer.

30. The method of claim 8, wherein the adhesion promoter is a methacrylate.

31. The method of claim 8, wherein layer thicknesses are in accordance with the following table:

| Layer | Layer thickness |
|---|---|
| Inner sealing or contact layer | 3 μm-150 μm |
| Adhesion promoter | 3 μm-40 μm |
| Barrier layer | 2 μm-80 μm |
| Central sealing layer | 3 μm-150 μm |
| Connecting layer | 3 μm-80 μm |
| Metal foil | 3 μm-65 μm |
| Outer structure | 0 μm-190 μm |

32. The method of claim 8, wherein layer thicknesses are in accordance with the following table:

| Layer | Layer thickness |
|---|---|
| Inner sealing or contact layer | 5 μm-100 μm |
| Adhesion promoter | 5 μm-25 μm |
| Barrier layer | 5 μm-50 μm |
| Central sealing layer | 5 μm-100 μm |
| Connecting layer | 5 μm-50 μm |
| Metal foil | 5 μm-40 μm |
| Outer structure | 0 μm-110 μm |

33. The method of claim 12, wherein said chromium-complex-comprising material is laquer-like.

34. The method of claim 14, wherein said modified olefins are ionomers.
